(19) United States
(12) Patent Application Publication
(10) Pub. No.: US 2015/0290673 A1
(43) Pub. Date: Oct. 15, 2015

(54) Apparatus and method for marking offset lines and curves

(71) Applicant: James Alvin Duncan, Riverside, CA (US)

(72) Inventor: James Alvin Duncan, Riverside, CA (US)

(21) Appl. No.: 13/999,969

(22) Filed: Apr. 9, 2014

(51) Int. Cl. B05C 17/12; G01C 3/08; B05D 1/02

(52) U.S. Cl. CPC B05C 17/12; B05D 1/02; G01C 3/08

(57) ABSTRACT

The invention relates to a spacing guide with a rigid body that is adjustable to various breadths, and a moveable offset distance indicator (pointer) that enables the user to measure offset distances from existing lines, curves and circles upon a surface, and simultaneously mark a second line, curve, or circle, in one easy step. The distance between the line or curve being marked, and the existing line, curve, or the radius of a circle is exactly the distance from the moveable offset distance indicator (pointer) and the embodied marking material source that does the marking. The offset distance is visible to the user by way of a scale over which the pointer is moved, and locked into place at the desired offset distance.

Where needed, a laser mounted in a forward position is used as an extended optical sighting means. A second laser can be mounted near the bottom of the unit, and used as a means to measure elevations or distances. This second laser pointed in a direction away from the unit, and aimed at a curb or vertically positioned ruler or measuring rod can provide such measurements.

The invention also provides a means for marking two parallel lines simultaneously at a consistent distance apart.

All the described embodiments of this invention can be made collapsible for convenient storage and transporting.

### SUMMARY

The invention relates to a marking system and method, used for marking accurate and continuously consistent lines, curves, and circles a distance away from an existing horizontal line, curve, or circle, or point. The invention employs a spacing guide in conjunction with a hand-held marking device containing marking material such as paint, chalk, or tape.

The spacing guide comprises an adjustable rigid body consisting of intersecting members to provide rigidity, a pole used as a handle necessary for easy and accurate drawing, a guide wheel means, or pointer means attached to said rigid body, the guide wheel for rolling against the face of a curb or other vertical surface, and the pointer for positioning over an existing line or curve, providing an accurate and continuously consistent distance between the vertical surface, horizontal line or curve, and the line or curve being marked; an optional laser mounted on the said pointer to be used as an extended optical sighting means, and two or more parallel street wheels attached at the bottom of the rigid body. The first said parallel street wheel is positioned in front, and the second said parallel street wheel positioned in the back, to provide stability and balance to the unit, cause the afore mentioned guide wheel to lie perfectly perpendicular against the curb or wall at all times, and keep the invention rolling parallel to the curb or wall with ease while marking the extended line or curve.

A second laser can be mounted near the bottom of the rigid body, the laser pointed in a direction away from the unit, and aimed at a ruler or measuring rod. This laser beam is used as a means to measure elevations. Alternately, an electronic distance measuring device (EDM) laser can be mounted on the rigid body, and aimed at a vertical surface in a direction approximately perpendicular from the unit. The offset distance between the vertical surface and the EDM is relayed back to the unit, and displayed digitally in view of the user.

A further object of the invention is to allow the user to draw circles of various radii by attaching a spike to the bottom of the rigid body. The spike is set at the desired distance away from the embodied marking device. The measured distance is shown by way of the scale on the bottom of the rigid body to which the spike is attached, now providing a radius. The said spike is pushed onto a surface or into permeable ground, and the unit pivots around the spike as the user rolls the unit along the ground while applying pressure to the trigger means of the paint or chalk source embodied on the unit, and thus a precise circle is produced upon said ground.

It is yet another object of the invention to allow the user to mark two parallel lines simultaneously, a fixed distance apart. This is achieved by replacing the aforementioned pole used as a handle with a second paint or chalk source, having a handle with a trigger means. The distance between the two parallel lines simultaneously marked is exactly the breadth of the rigid body positioned between the two paint sources attached there to.

### RELATED APPLICATION

This invention claims priority from provisional patent no. 61/853,819 Filing date: Apr. 12, 2013.

### BACKGROUND OF THE INVENTION

1. Field of Invention

The field of the invention relates to marking paint or chalk lines, curves, and circles on a surface. The invention will be used primarily for, but not limited to the many facets of construction work, landscaping projects, marking out sport fields, parking lots, floors, motion picture sets, and street surfaces. The invention consists of a spacing guide (and method) that when attached to a hand-held marking device or paint source, enables the user to mark accurate and continuously consistent lines, curves, and circles at various distances away from a vertical surface or an existing line; and draw circles of various radii around an existing point on a surface.

2. Description of Prior Art

Marking extended lines in an accurate and consistent distance from a vertical surface, or existing line, has been achieved by using a chord or string line; where the desired distance is measured from the vertical surface or existing line at both extreme ends of the string, using tape measures or rulers, and a third person then paints over the string line on the ground.

Marking circular curves an accurate distance from a vertical surface or existing curve has been achieved by using a survey instrument such as a transit to sight on a stake or marking pin, turn angles repetitively, and set stakes or marks on the ground in line with each turned angle until the length of the circular curve has been marked out.

Drawing smaller circles upon a surface has been achieved by using a measuring tape, setting the “0” end of the tape at what would be the center of circle, and placing a series of marks on the surface a consistent measured distance from the center point, until marks are made completely around the center point, producing a circle.

The problem with these methods of marking extended lines, curves, and circles a measured distance away from an existing line or curve, or around a point on a surface is that they require more than one person, take a considerable amount of time, and in most cases, require repetitive bending or stooping, subjecting the person to back pain, strain, or injury.

U.S. Pat. No. 6,698,774 B2 provides a device that can allow the user to mark extended lines and curves on a surface a consistent distance away from a vertical surface or existing line without repetitive measuring, bending, and stooping. However, the limitations with this tool is that it is restricted to operating within an offset distance of four feet, and it does not adjust to various breadths; and does not adjust to various offset distances. It does not adjust to draw circles of various radii around a point.

There exists no such device with a pointer used as an offset distance indicator adjustable to various distances across the bottom of the unit, and away from the paint source; with an optional laser mounted on the said pointer, to be used as an extended optical sighting means. No compact, lightweight, easy to use, easy to maneuver, mobile marking device exists that has a laser mounted on it to be used to read elevations, or to measure offset distances electronically while simultaneously marking out offset lines. There exists no such device for drawing circles upon a surface, employing a spike to enable the user to pivot the unit on a surface, holding the instrument in place a set distance away from the paint source, producing a radius, and allowing the user to draw a circle while walking in a natural, erect position.

### BRIEF DESCRIPTION OF THE ILLUSTRATIONS

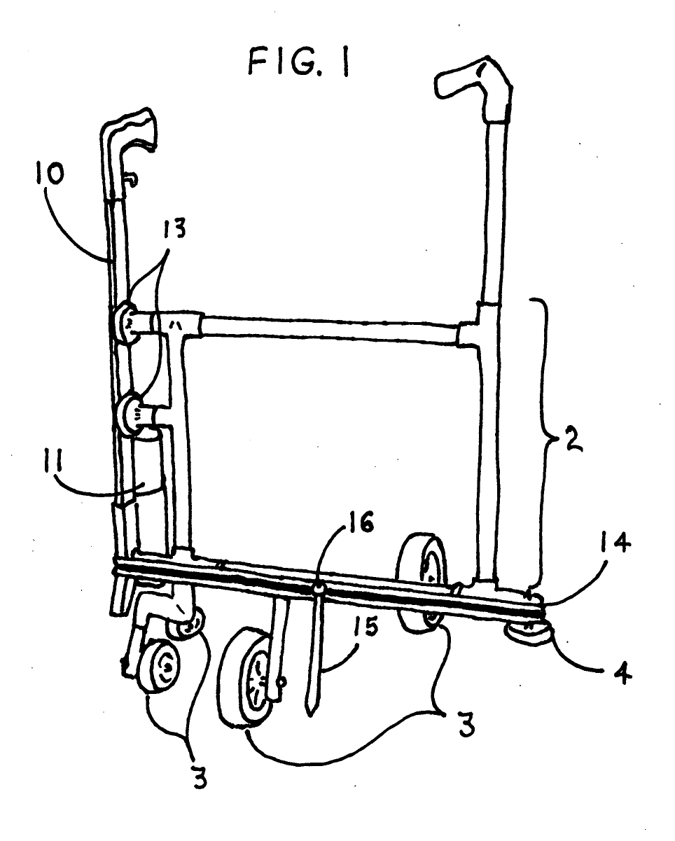

FIG. 1 is a front view of the apparatus for marking offset lines and curves.

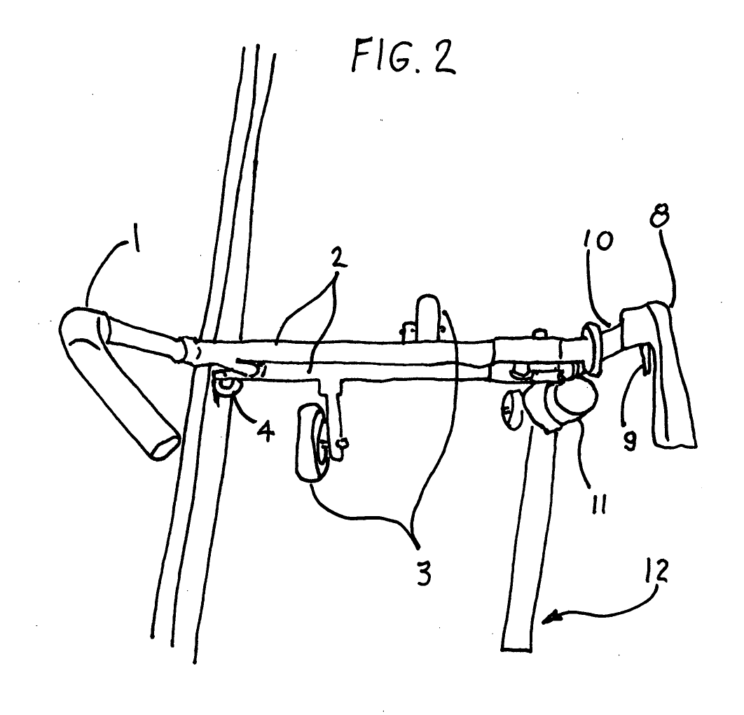

FIG. 2 is a top view of the apparatus for marking offset lines and curves in use with guide wheel positioned against a vertical surface to provide the continuously consistent spacing between the vertical surface and line being marked.

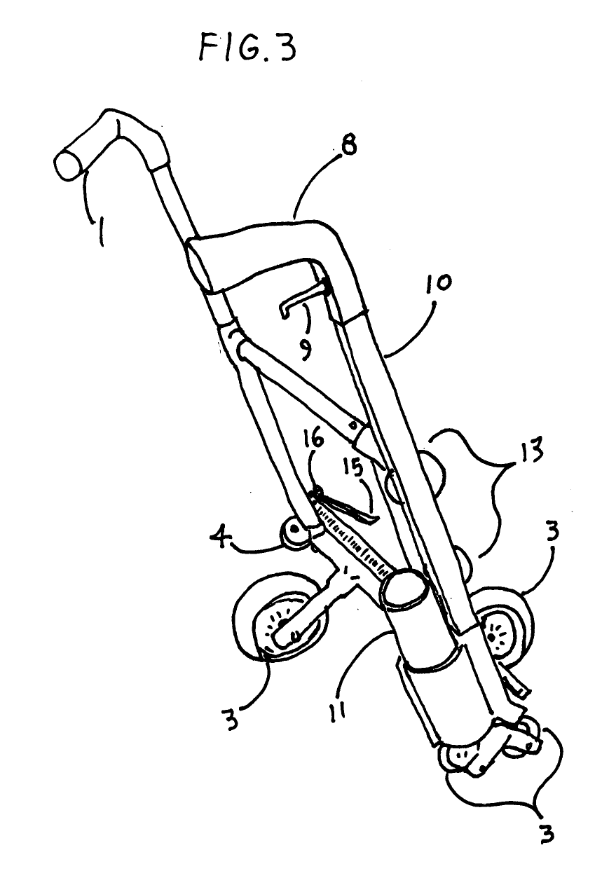

FIG. 3 is a side view of the apparatus for marking offset line and curves.

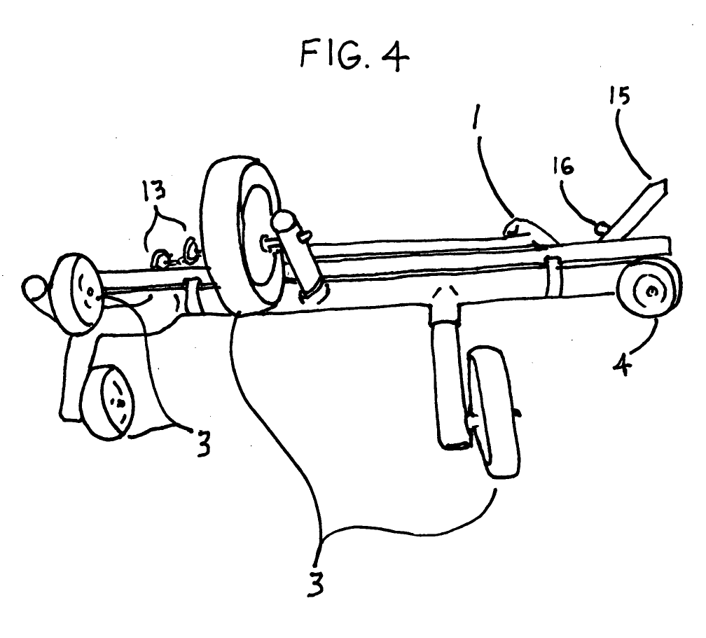

FIG. 4 is a bottom view of the spacing guide with scale and moveable offset distance indicator.

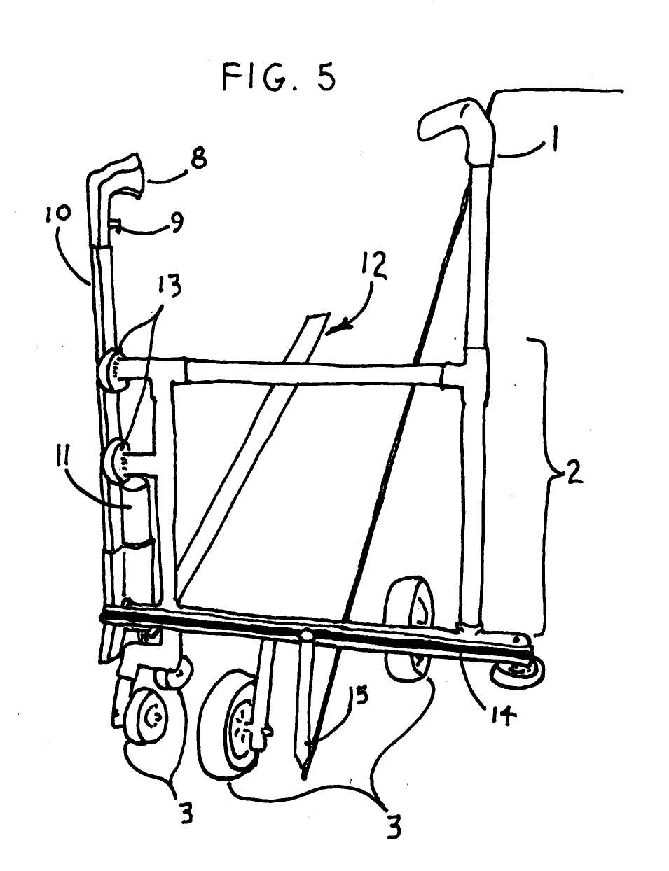

FIG. 5 is a front view of the apparatus for marking offset lines and curves, with scale and moveable offset distance indicator (pointer) in use. The pointer is pointed above the edge of pavement, and a line is marked the indicated distance away from the edge of pavement.

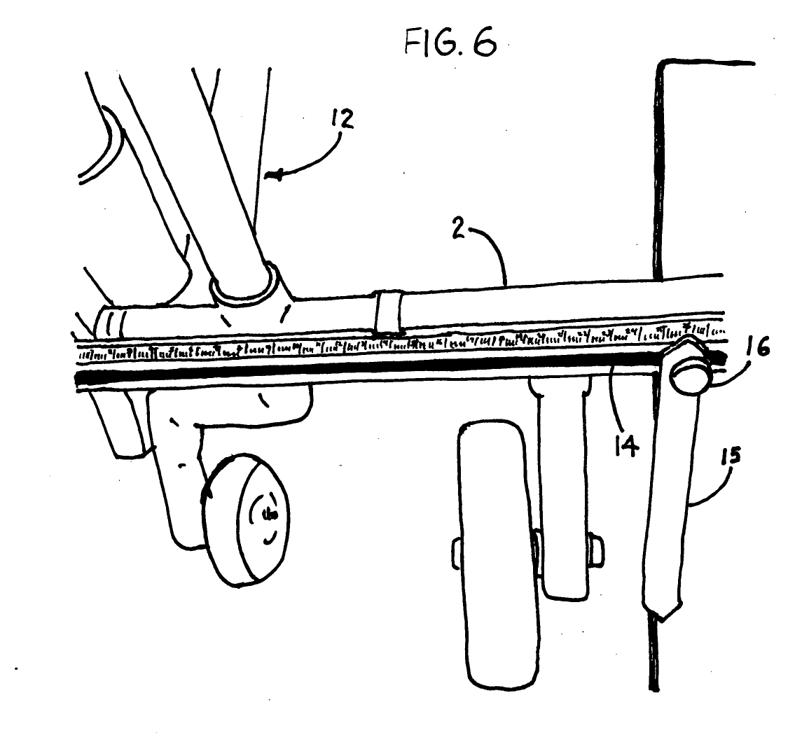

FIG. 6 is a close-up view of the offset distance indicator (pointer) and scale. The pointer is locked in place on the scale, at the indicated distance from the paint source, and positioned above the point or line of reference as a continuously consistent offset line is being marked.

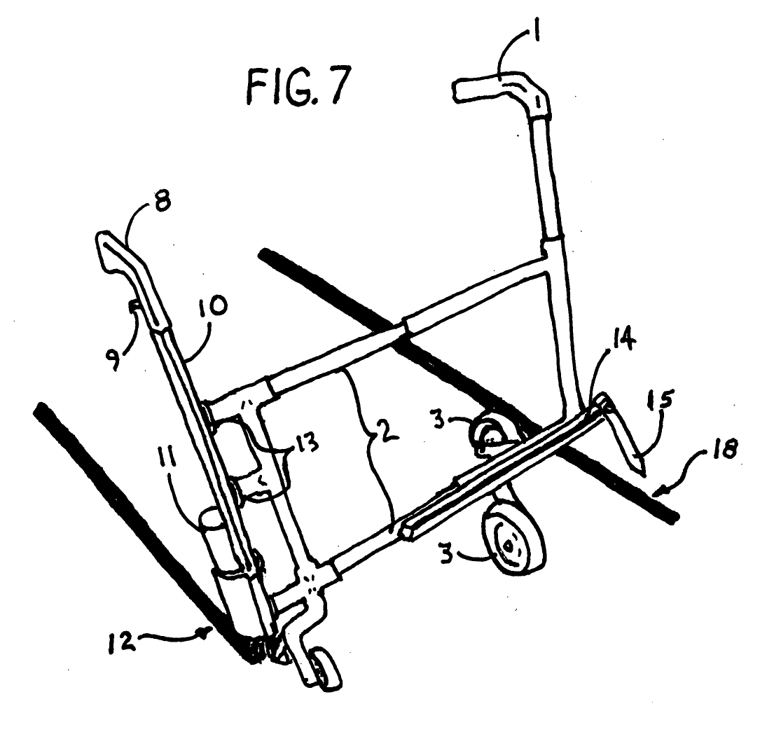

FIG. 7 is a front view of the present invention in use, with the rigid body extended to a broader breadth, and a second continuously consistent parallel line is marked the indicated distance away from the first existing line.

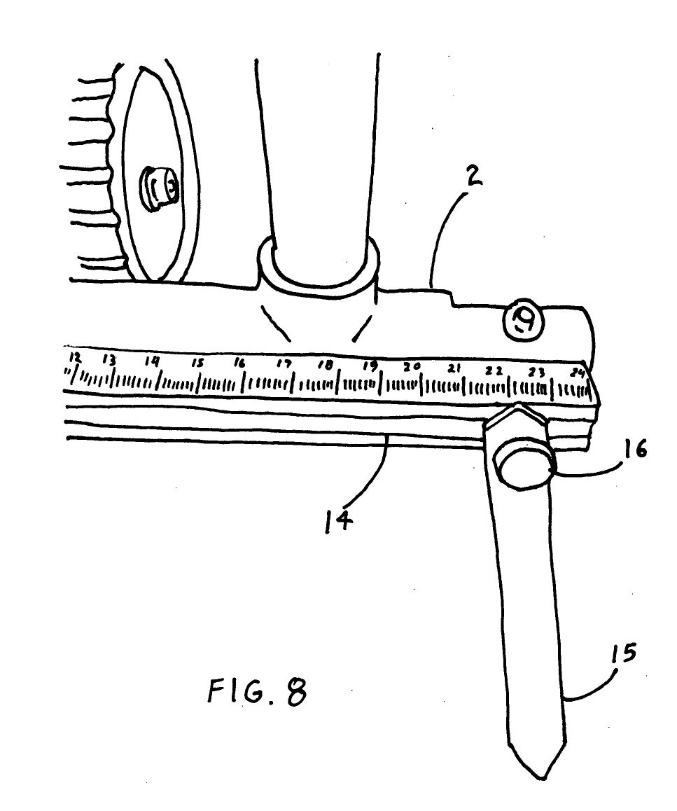

FIG. 8 is a perspective view of the scale and offset distance indicator (pointer) positioned above the referenced existing line in order to paint a second continuously consistent parallel line the indicated measured offset distance away from said existing line.

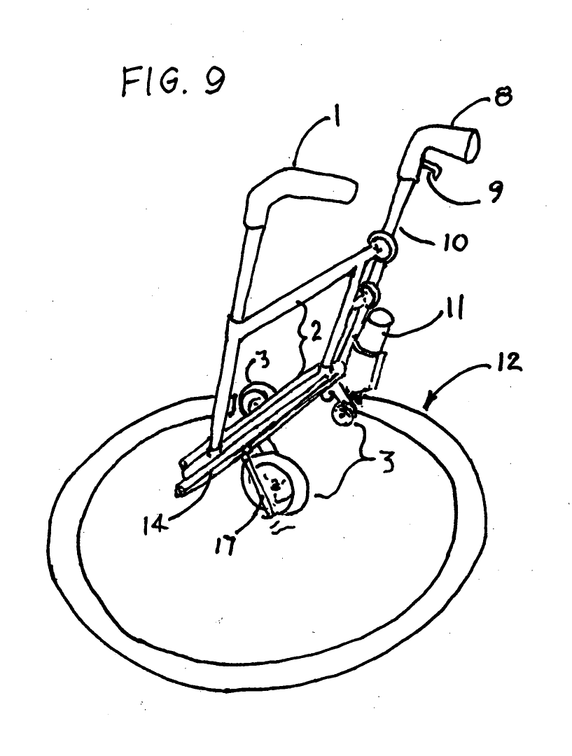

FIG. 9 is a perspective view of the present invention in use, drawing a circle upon the ground. The spike set in the ground at a point that would be the center of the circle being drawn, and the radius of the circle indicated by position on the scale where the spike is located and attached.

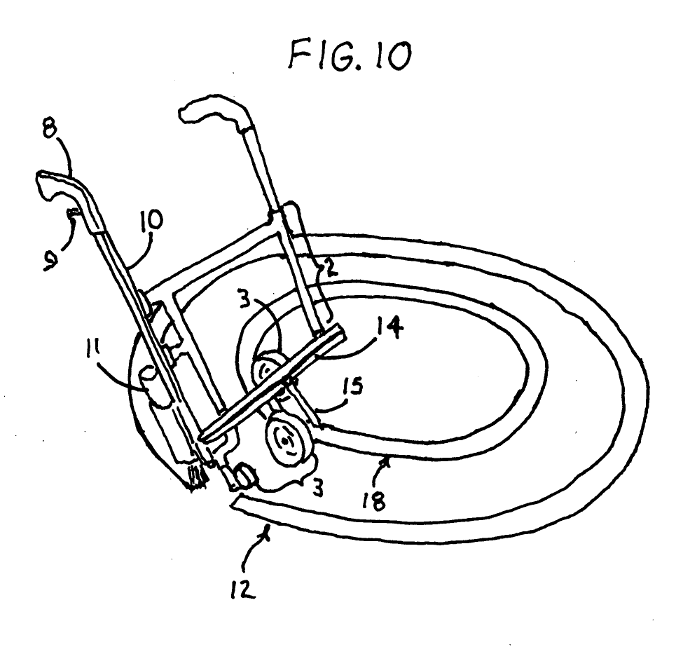

FIG. 10 is a perspective view of the present invention in use, drawing a second concentric circle around an existing circle, the offset distance indicated by the position on the scale where the pointer is locked in place, and positioned above the existing circle.

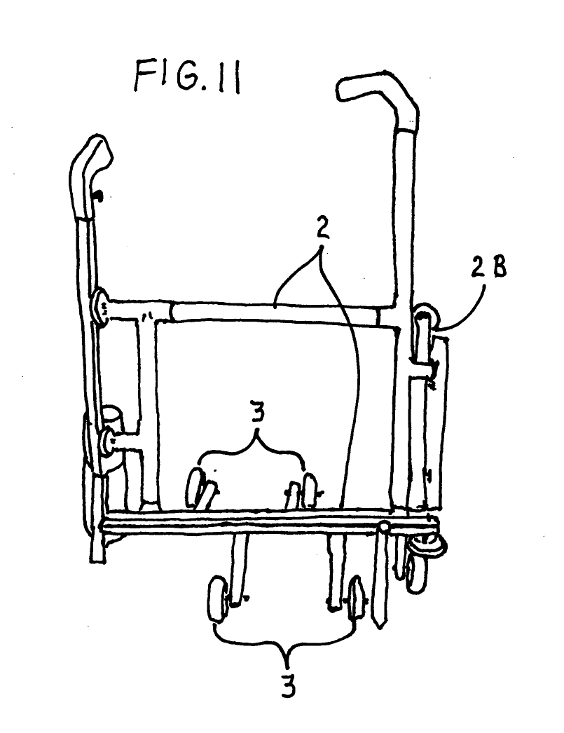

FIG. 11 is a front view of the apparatus for marking offset lines and curves with a rigid body extension clipped to the side of the rigid body, where it is stored for future use.

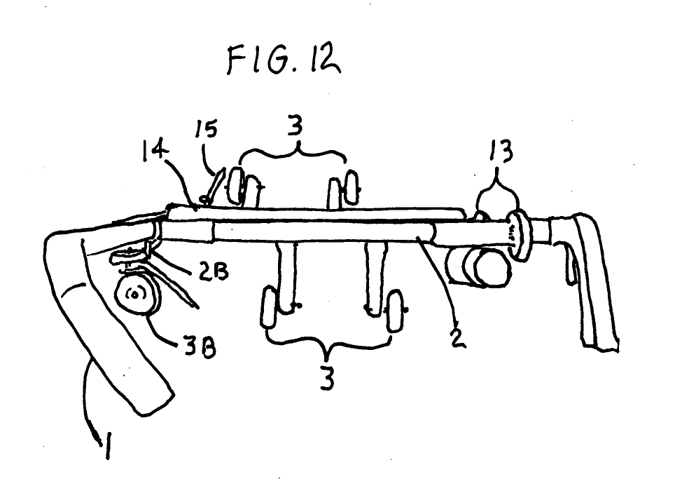

FIG. 12 is a top view of the apparatus for marking offset lines and curves, with an extension clipped to the side of the rigid body.

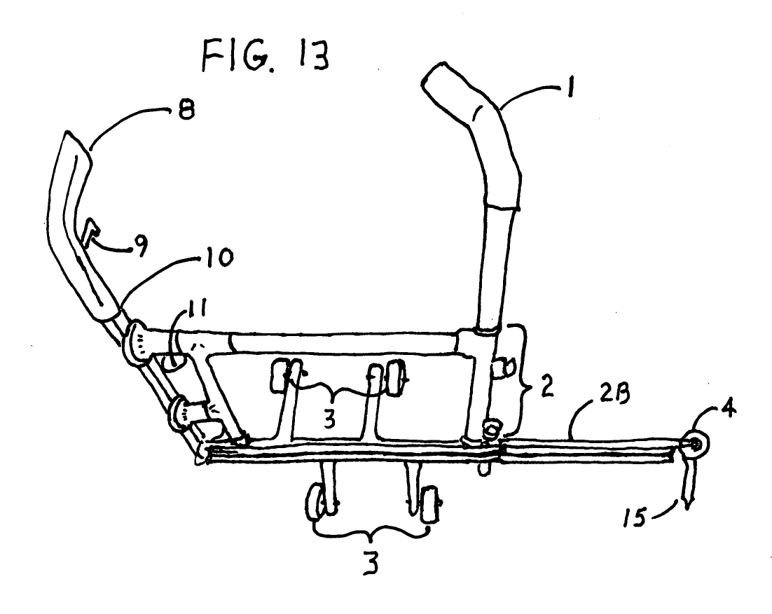

FIG. 13 is a top view of the apparatus for marking offset lines and curves, with the rigid body extension attached.

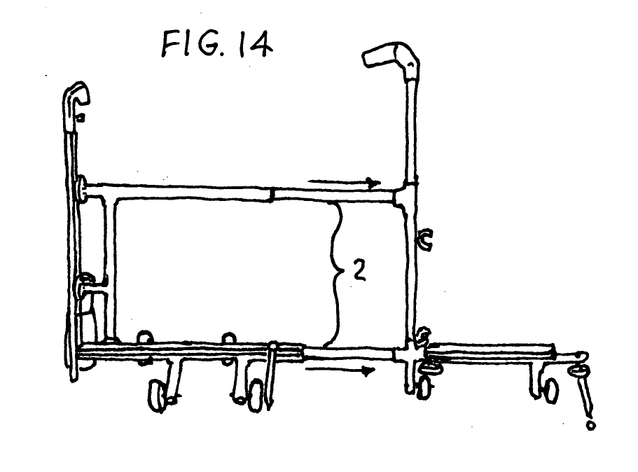

FIG. 14 is a front view of the apparatus for marking offset lines and curves with the extension attached, and the rigid body extended telescopically for a broader range.

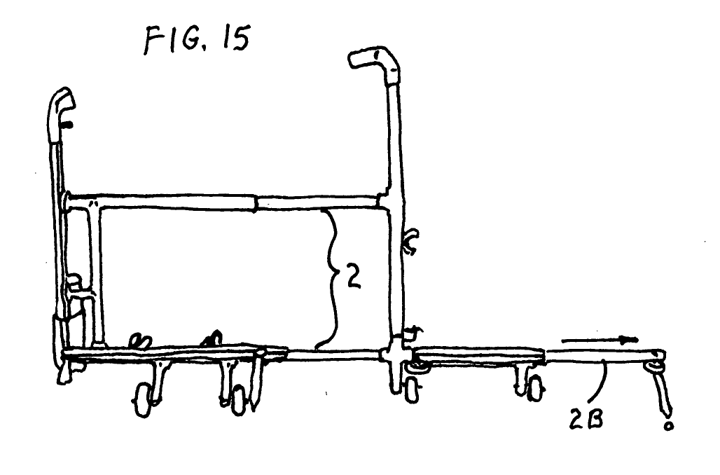

FIG. 15 is a front view of the apparatus for marking offset lines and curves, with rigid body extended telescopically, and the extension attached and further extended telescopically for a maximum range.

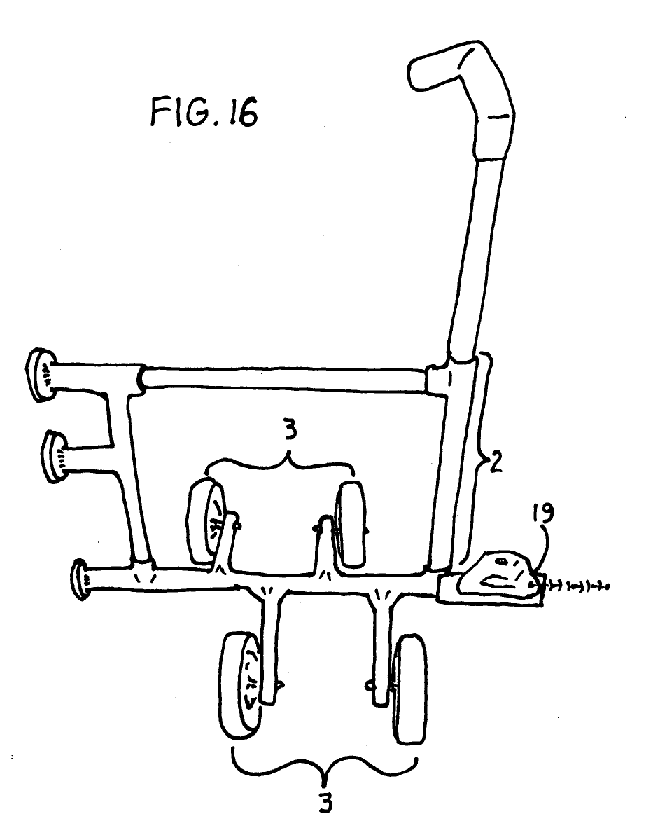

FIG. 16 is another embodiment of the present invention comprising at least four street wheels, and a laser mounted on the bottom of the rigid body.

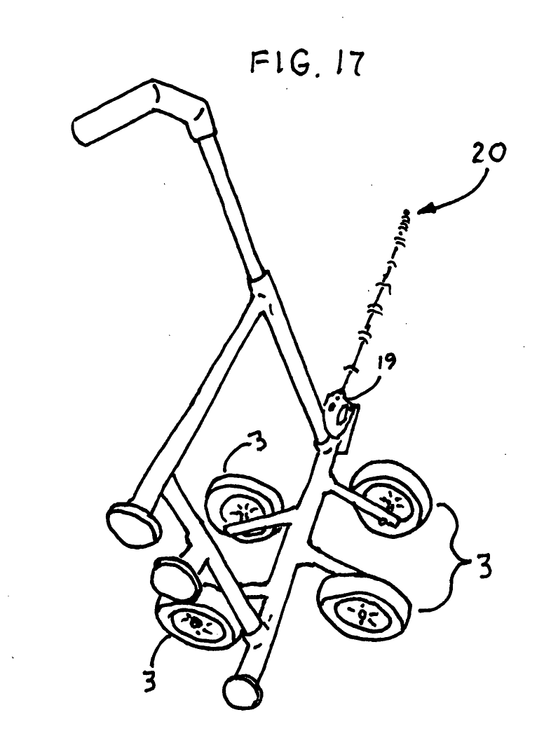

FIG. 17 is a perspective view of an embodiment of the present invention comprising at least four wheels, and a laser mounted on the rigid body. The laser is pointed away from the unit, in a direction perpendicular to the direction of travel.

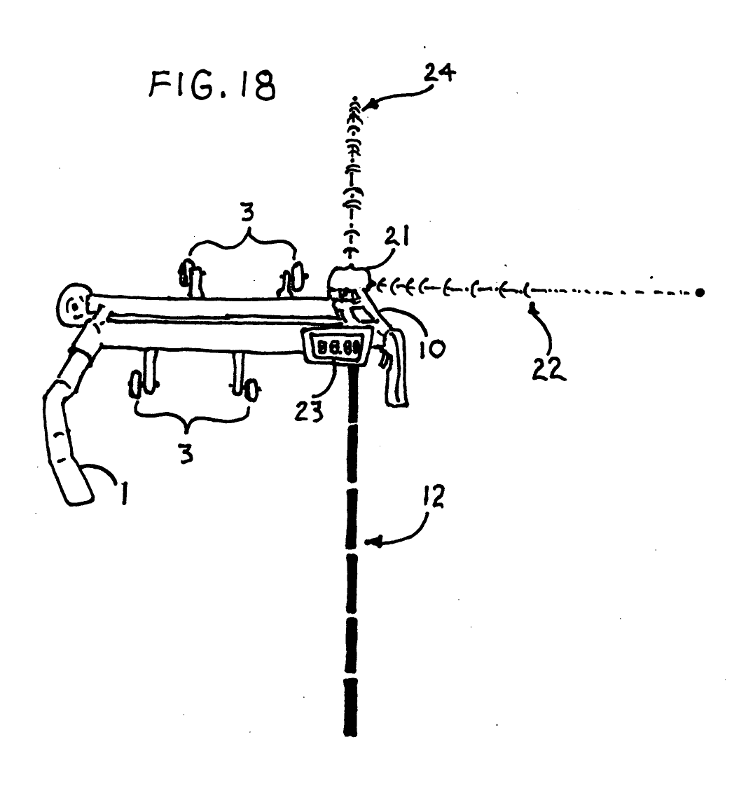

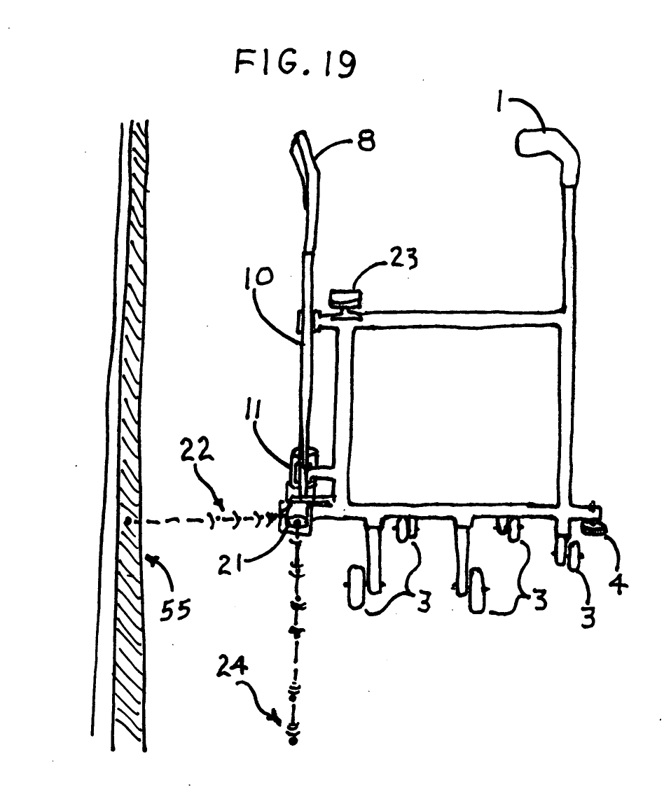

FIG. 18 and FIG. 19 are top and front views, respectively, of the apparatus for marking offset lines and curves, with an electronic distance measuring device laser mounted to the bottom of the rigid body, and pointed away from the unit in a direction perpendicular to the direction of travel. The laser light is bounced off of a vertical surface it is aimed at, and the offset distance from the vertical surface to the laser housing is relayed and shown on a digital readout in view of the user.

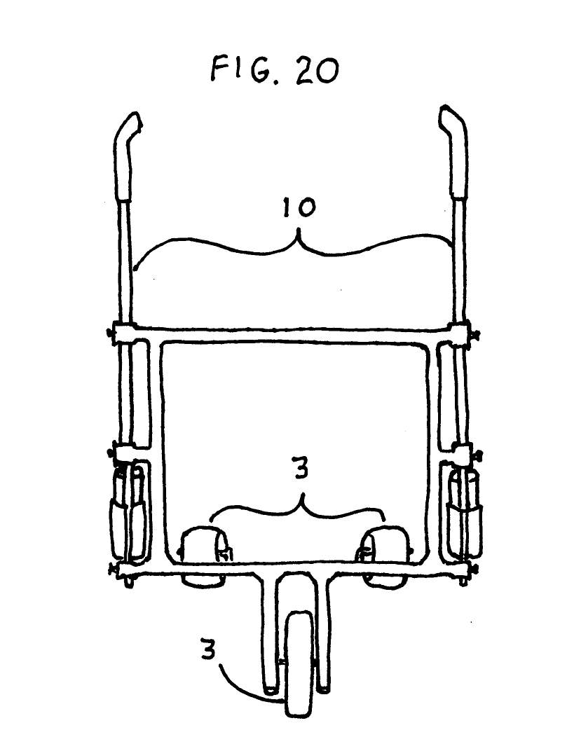

FIG. 20 is a front view of an embodiment of the present invention wherein a second marking device is mounted on the opposite end of the rigid body from the first marking device. This embodiment enables the user to mark two parallel lines simultaneously.

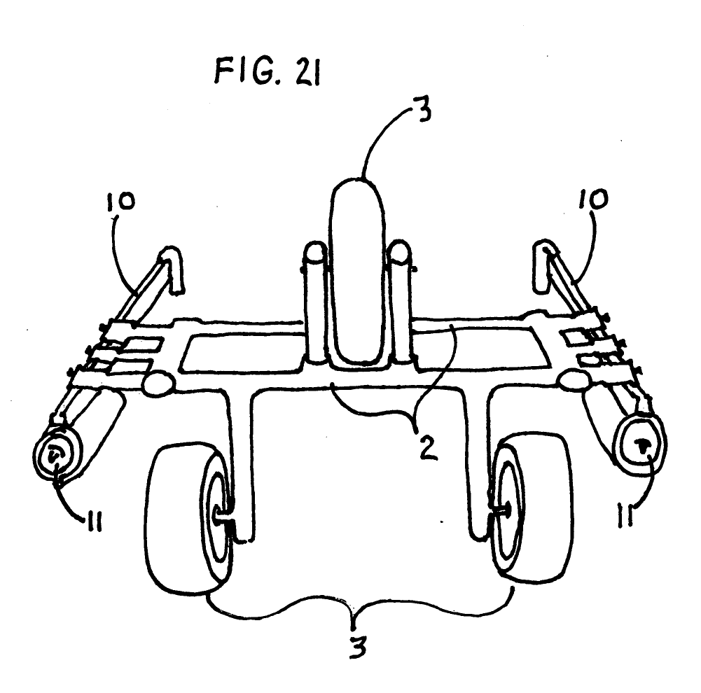

FIG. 21 is a bottom view of an embodiment of the present invention comprising at least three parallel street wheels positioned on opposite sides of the rigid body; one in front, and two in back of the said rigid body. There are two marking devices positioned at opposite ends of the rigid body for marking two parallel lines a fixed distance apart.

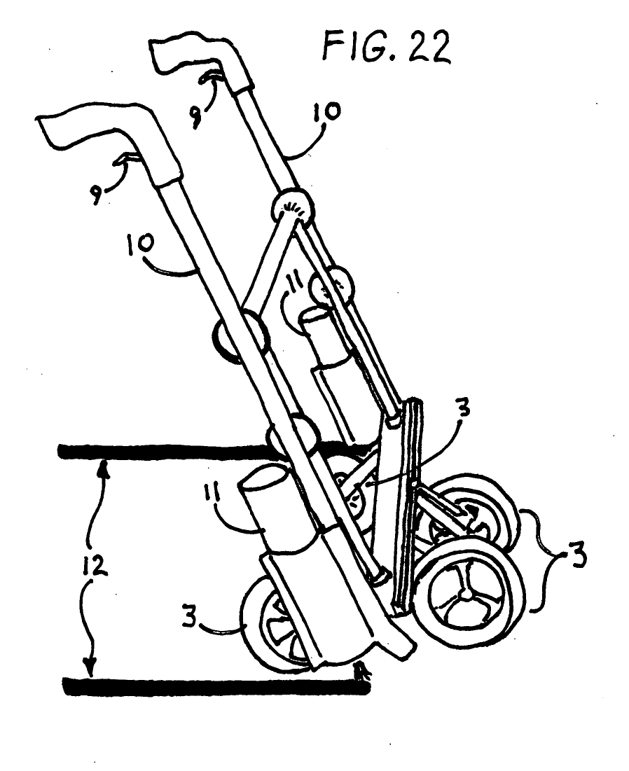

FIG. 22 is a side view of an embodiment of the present invention comprising at least four street wheels, and two marking devices for marking two parallel lines simultaneously.

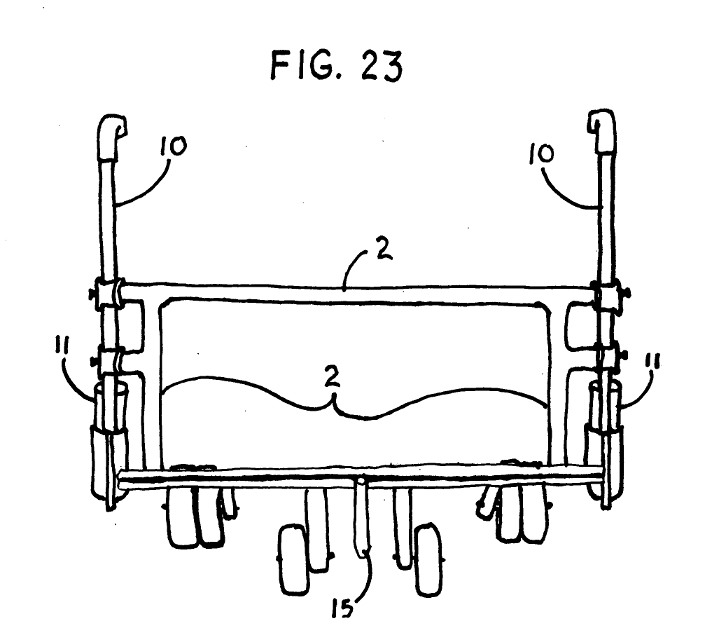

FIG. 23 is a front view of an embodiment of the present invention comprising two marking devices on opposite ends of the rigid body, and a pointer mounted at the mid point between the two marking devices, the pointer used as an optical sighting means for keeping the device centered over a point of reference.

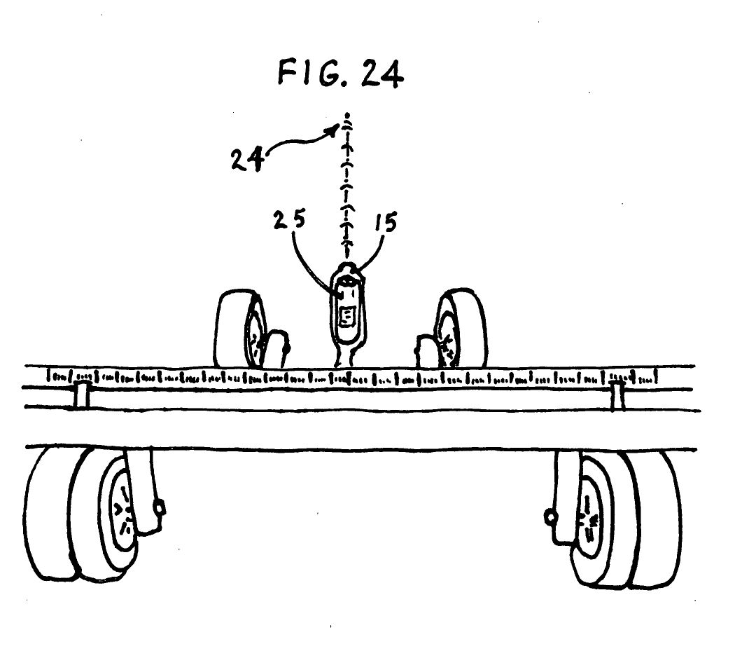

FIG. 24 is a top view of the present invention wherein the pointer is positioned at the center point of the rigid body, a laser pen attached there to, and the laser beam used as an extended optical sighting means.

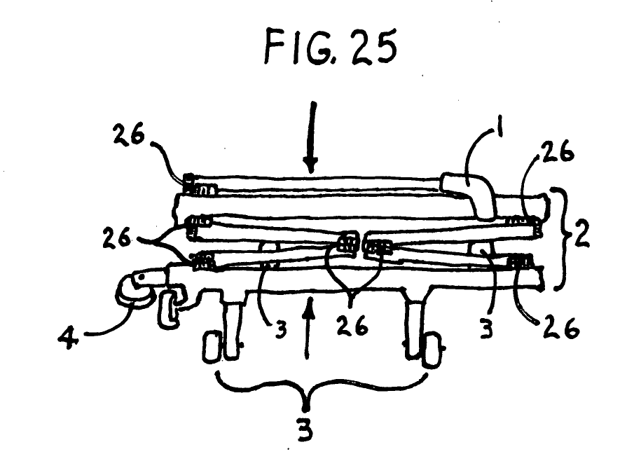

FIG. 25 is a perspective view of an embodiment of the present invention wherein hinges are used to put the unit in a collapsed configuration for easy transporting and convenient storage.

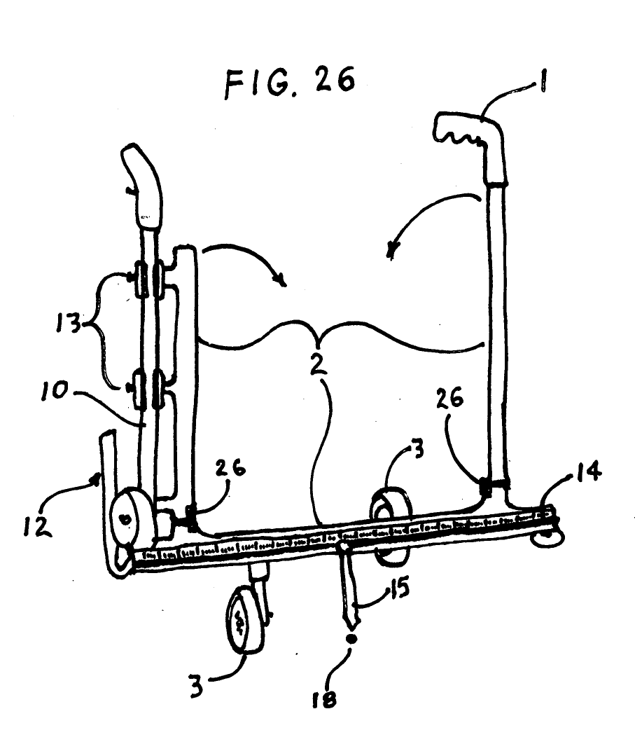

FIG. 26 a front view of an embodiment of the apparatus for marking offset lines and curves wherein a tape dispenser is mounted for use as a marking material source (alternately a paint or chalk applicator can be used), and the rigid body having at least one horizontal member positioned near the bottom of the unit and hinges disposed near the points where the horizontal and vertical members intersect, providing a means to quickly and easily put the device in a collapsed position for convenient storage and transporting.

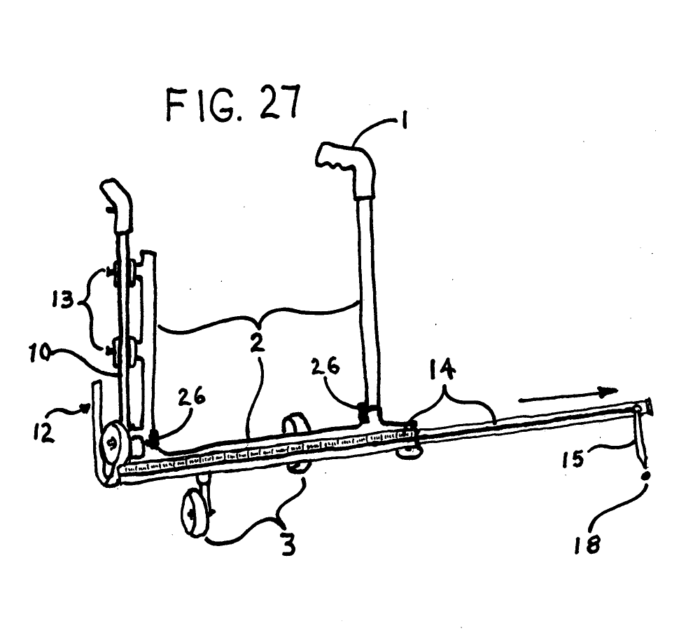

FIG. 27 is a front view of an embodiment of the present invention where the scale is expandable to increase the range of measuring capability and to extend the reach of the pointer means.

### DETAILED DESCRIPTION OF THE PREFERRED EMBODIMENTS 1

FIG. 1, FIG. 2, FIG. 3, and FIG. 4 are views of the present invention in its compact form. FIG. 1 is a front view, FIG. 2 is a top view, FIG. 3 is a perspective side view, FIG. 4 is a bottom view.

In FIG. 1, FIG. 2, FIG. 3, and FIG. 4, 1 is the pole, used as a handle which is attached to the rigid body 2 consisting of intersecting members, providing rigidity and consistent spacing between the paint or chalk source 11 and the edge of the guide wheel 4, whose function is to roll against a vertical surface making continuous contact, ensuring a continuously consistent offset distance to the paint or chalk source 11. 15 is the pointer, used as an optical sighting means when there is no vertical surface to employ. The said pointer is set at a point on the scale 14 by the user, and locked into place by locking means 16. The offset distance from the paint source 11 to the pointer 15 is indicated by the graduating numerals on the scale 14, upon which the said pointer is slidably mounted. The spray gun body 10 is attached to the rigid body 2 by way of magnets 13 (alternately tangent screws or locking pins can be used as a means of attaching a spray gun body). The spray gun comprises a paint or chalk reservoir located near the bottom end of the said spray gun body, a handle means 8 at the top end of the spray gun body, with a trigger means 9 for releasing paint or chalk from the reservoir 11.

In FIG. 2, the guide wheel 4 is in contact with a vertical surface, and the invention is positioned to mark a continuously consistent line. The user pushes the unit with the pole handle 1 in one hand and the spray gun handle 8 in the other hand. The unit is supported and balanced by the rotatably mounted parallel street wheels 3 as they roll along the ground. Marking material is released from a spray gun, located at the end of the rigid body 2 opposite the said guide wheel, by applying pressure to the trigger means 9 near the handle 8 located at the top end of the spray gun body 10. A continuously consistent line 12, is subsequently marked on the ground an offset distance from the vertical surface exactly equal to the breadth of the rigid body 2.

As illustrated in FIG. 4, a bottom view of the present invention, the parallel street wheels 3 support the unit and provide balance so that when in use, the guide wheel 4 automatically rests perpendicularly against a vertical surface and rolls along the vertical surface with ease, in the direction of travel.

FIG. 5 demonstrates how an offset line is marked a particular distance from a pavement edge. In FIG. 5, the pointer 15 is positioned above an edge of pavement, with the spray gun body 10 positioned a distance away from the said pointer 15. The offset distance of the marking material source 11 from the said pointer is indicated by a numeral on the scale 14 at the location where the said pointer is attached and locked onto the said scale. Accordingly, a line 12 is marked on the terrain off the edge of pavement exactly the offset distance from pointer positioned above the edge of pavement, to the marking material source 11 from which the said marking material is dispensed. The steps taken to dispense the marking material from the reservoir are described in FIG. 2.

FIG. 6 and FIG. 8 are close-up views of the pointer 15 which is slidably mounted on the scale 14, which has graduated numerals to indicate offset distances from the paint or chalk source to a location where the said pointer 15 is positioned, and locked into place by way of the locking means 16. The said scale 14 is attached to the bottom of the rigid body 2.

In FIG. 6, the pointer 15 is positioned over an edge of pavement in order to mark a parallel line 12 on the terrain a consistent distance away from the edge of pavement.

In FIG. 7, the pointer 15 is positioned over the existing painted line a distance away from the paint source 11, in order for a second parallel line to be marked a continuously consistent distance away from the existing painted line. In this embodiment, the rigid body 2 is extended telescopically by way of the horizontally positioned members which are slidably mounted, producing a broader rigid body, thus resulting in a greater offset distance between the two parallel lines.

FIG. 9 is a perspective view of the invention whereby a circle is drawn upon a terrain. The spike 17 is positioned on the scale 14, located at the bottom of the rigid body 2, locked into place, and partially inserted into the terrain. With the spike planted into the terrain, the invention is pivoted around the spike on the parallel wheels 3, and a circle is drawn by applying pressure to the trigger means 9, located near the top of the spray gun body 10, causing marking material to be released from the reservoir 11. The radius of the circle is exactly the distance from the spike to the marking material reservoir (paint or chalk source) 11. The user holding the embodied pole used as a handle 1 in one hand, and the spray gun handle 8 in the other hand, can draw a circle with ease very quickly and accurately, while in a natural erect walking position.

FIG. 10 is a perspective view of the present invention wherein a second concentric circle is drawn by positioning the pointer 15 above the circumference of the existing circle 18. The invention is supported by the parallel street wheels 3, providing balance and stability to the unit, as the user pushes it along, keeping the said pointer 15 above the circumference of the existing circle 18 at all times, and applying pressure to the trigger means 9, which releases marking material from the reservoir 11, producing a second concentric circle 12 a distance away from the said pointer 15 to the marking material reservoir 11, as indicated by the numeral on the scale 14 where the said pointer is positioned.

FIG. 11 and FIG. 12 are perspective views of an embodiment of the present invention comprising at least four street wheels 3, and a rigid body extension 2B to further increase the range of the rigid body 2. FIG. 11 is a front view and FIG. 12 is a top view.

In FIG. 12 the rigid body extension 2B is stored on the side of the rigid body 2. The numerals on the scale 14, located on the bottom of the rigid body 2, are visible to the user. 13 are the magnets used as a quick-release attaching means for the spray gun. The rigid body extension 2B has at least one additional parallel street wheel 3B to provide further stability and support to the unit when attached thereto and in use.

FIG. 13 is a front-facing top view of an embodiment of the present invention, with the rigid body extension 2B attached, providing more range to the unit. At least one additional guide wheel 4 and an additional pointer 15 are mounted on the rigid body extension 2B, to be used in the same manner as described in FIG. 1, FIG. 2, FIG. 3 and FIG. 4. The spray gun body 10 is attached to the unit by way of the attaching means 13.

In FIG. 14, the rigid body 2 is extended telescopically to provide more range to the unit, and more breadth to the rigid body.

In FIG. 15, the rigid body 2 is extended telescopically, and the rigid body extension 2B is extended telescopically as well to provide maximum range to the rigid body in order to measure maximum offset distances.

FIG. 16 is a perspective view of an embodiment of the present invention comprising at least 4 parallel street wheels 3 positioned on opposite sides of the rigid body 2, providing balance and stability to the unit, and an optional laser 19 mounted upon the said rigid body.

FIG. 17 is a side view of an embodiment of the present invention comprising at least four street wheels 3, and a laser 19 mounted upon the unit. The laser housing 19 is aimed in a direction away from the unit, and a laser beam 20 is projected there from. The said laser beam-can be used as a means to read relative elevations when pointed at a measuring device such as a rod, a ruler, or a measuring tape (not illustrated).

FIG. 18 is a top view of the present invention wherein an electronic distance measuring device (EDM) 21 is mounted upon the bottom of the rigid body 2, and aimed in a direction perpendicular to the direction of travel. A laser beam is projected from the EDM to a vertical surface, a distance away, and the said distance from the EDM to the vertical surface is relayed back to the unit. A digital readout 23 showing the said offset distance is displayed on the unit, in view of the user. A second laser beam 24 is projected from a laser means (not shown in this illustration, see FIG. 19), mounted on the bottom of the rigid body. The said second laser beam 24 is positioned in a forward direction, approximately perpendicular to the beam of the EDM, and in line with the painted line 12. As the unit is moved over a surface, the laser 24 is used as an extended optical sighting means for the user, to ensure that the unit is constantly headed precisely in the direction of the intended path of travel.

FIG. 19 is a front view of the present invention wherein an electronic distance measuring device (EDM) 21 is mounted upon the bottom of the rigid body, and aimed in a direction perpendicular to the direction of travel. A laser beam is projected from the EDM to a vertical surface 55, a distance away, and the said distance from the EDM to the vertical surface is relayed back to the unit. A digital readout 23 displaying the said offset distance is disposed on the unit, in view of the user. A second laser beam 24 is projected from a laser means mounted on the bottom of the rigid body. The said second laser beam 24 is positioned in a forward direction, approximately perpendicular to the beam of the EDM. As the unit is moved over a surface, the laser 24 is used as an extended optical sighting means for the user, to ensure that the unit is constantly headed precisely in the direction of the intended path of travel.

FIG. 20 is an embodiment of the present invention comprising at least three street wheels 3, and two marking devices or spray gun bodies 10 to enable the user to mark two parallel lines simultaneously.

FIG. 21 is a bottom view of the embodiment of the present invention comprising at least three street wheels 3 and two spray gun bodies 10 with marking material sources 11 to enable the user to mark two continuously consistent extended parallel lines simultaneously. The consistent spacing between the two said lines is exactly equal to the breadth of the rigid body 2 and the paint sources 11.

FIG. 22 is a side view of an embodiment of the present invention comprising two marking devices 10 for marking two parallel lines 12 simultaneously by pushing the unit forward, and applying pressure to the trigger means 9, to release marking material stored in the reservoirs 11, producing two parallel lines 12.

FIG. 23 is a front view of an embodiment of the present invention comprising two spray gun bodies 10 with marking material sources 11 located at opposite ends of the rigid body 2, capable of producing two parallel lines simultaneously. A moveable pointer 15 is positioned at the center point of the rigid body 2 to be used as an optical sighting means and visual guide to center the two parallel lines being marked.

FIG. 24 is a top view of an embodiment of the present invention wherein an optional laser pen means 25 is mounted on the pointer 15, and pointed in a direction in front of the unit, in the direction of travel. The laser beam 24 projected from the laser pen means 25 is used as an extended optical sighting means for the user to keep the unit on line and heading precisely in the intended path of travel while marking extended lines.

The present invention being light weight and compact, lends itself to easy and convenient usage. When hinges are installed to the vertical members of the rigid body, and near the points where the horizontal and vertical members intersect, a surprising result is realized. The unit becomes collapsible into a very compact form.

Accordingly in FIG. 25, the rigid body 2 is collapsed into a compact position by way of the hinges 26 herein shown in an open position. The pole used as a handle 1 as well as the rigid body 2, are collapsed to a very close proximity to the parallel street wheels 3 and guide wheel 4 located at the base of the unit. In this collapsed position, the invention can be stored in a carrying case or a bag for easy and convenient transporting and storage.

In FIG. 26, an elongated tape dispenser body 10 is attached to the rigid body 2 by attaching means 13. The said tape dispenser is used as a means for placing marking material 12 upon a surface a measured distance away from an existing point 18 on the ground, the said measured distance exactly equal to the numeral on the scale at which point the pointer means 15 is attached. The said scale comprises graduating numerals, starting with “0” at the position where the marking material means is attached to the unit. In this embodiment, the rigid body 2 comprises at least two vertically positioned members and at least one horizontally positioned member. The horizontally positioned member is located near the base of the unit, and having hinges 26 disposed near the point where the vertical and horizontal members intersect, the unit can be easily collapsed for convenient transporting and storage by folding the vertically positioned members toward the base of the unit.

FIG. 27 is a front view of an embodiment of the present invention wherein the scale 14 is positioned approximately horizontally on the bottom of the rigid body 2, and extended telescopically by means of the slidably mounted scale members 14. The pointer means 15 is positioned towards the end of the said scale 14 in order to reach and measure an existing point 18 on the ground, and simultaneously mark the surface with marking material 12, the said measured distance away from said point 18.

I claim:

1. A line and curve marking apparatus having a spacing guide attached to a marking device containing marking material such as paint, chalk, or tape, which enables a user to mark an extended line or curve on a surface, at a consistent distance away from a vertical surface, horizontal line, curve, or point, comprising:
a rigid body positioned in approximately a vertical position, the rigid body including generally vertically positioned members, horizontally positioned members slidably mounted providing adjustability to the said rigid body;
a guide wheel means attached to said rigid body for rolling against a vertical surface providing an accurate and continuously consistent distance between the said vertical surface and line being marked;
a plurality of street wheels attached to the bottom of the rigid body parallel to the direction of travel providing balance and stability to the unit;
a scale and moveable pointer means mounted on the rigid body, the scale comprising numerals to indicate an offset distance from a paint source, and the moveable pointer used as an offset distance indicator mounted there to, the said moveable pointer embodying a locking means allowing the user to set said pointer at the desired location along the scale, lock said pointer into place, and position said pointer above an existing point of reference on the ground, to use as a visual guide to simultaneously measure and mark an offset line or curve the now indicated distance away from the said point of reference;
a handle positioned on one end of the rigid body for a hand of the user to push and steer the unit;
and the said marking material source attached on the opposite end of the said rigid body with a handle and trigger means to be used by another hand of the user for releasing said marking material.

2. The spacing guide in claim 1 wherein the moveable pointer is a spike means, the said spike means planted onto a surface, and used as a pivot point, thereby providing a radius to enable the user to draw circular curves upon said surface while in a natural, walking position.

3. The spacing guide in claim 1 having an additional horizontal member extension, used as a means to further increase the range and breadth of the rigid body.

4. The spacing guide in claim 1 wherein the rigid body is collapsible for easy storage and transporting.

5. The spacing guide in claim 2 wherein the rigid body is collapsible for easy storage and transporting.

6. The spacing guide in claim 1 having at least one housing and laser means mounted upon the pointer means, to be used as an extended optical sighting means on the ground, in the direction of travel.

7. The spacing guide in claim 1 having at least one housing and laser attached, positioned in a direction perpendicular to the line of travel.

8. The spacing guide in claim 1 having at least one housing and laser attached, positioned in a direction perpendicular to the line of travel, wherein the said laser means is an electronic distance measuring device; and a digital read out displaying said distance in view of the user.

9. The spacing guide in claim 1 having at least one housing and laser means mounted in a forward position, to be used as an extended optical sighting means on the ground, in the direction of travel, and a second housing and laser means positioned in a direction perpendicular to the line of travel, wherein the said second laser means is an electronic distance measuring device capable of measuring an offset distance to a vertical surface; and a digital read out displaying said distance in view of the user.

10. The scale and pointer in claim 1, the said scale comprising numerals to indicate an offset distance from a marking material source, and a moveable pointer used as an offset distance indicator mounted to said scale, the said moveable pointer embodying a locking means which allows the user to set said pointer at the desired location along the scale, lock said pointer into place, position said pointer above an existing point of reference on a surface, and use as a visual guide to simultaneously measure and mark an offset line or curve on said surface, the now indicated offset distance away from said point of reference, while in a natural erect walking position.

11. The scale and moveable pointer in claim 1 wherein the said moveable pointer is a spike used as a pivot point on a surface to enable the user to draw circular curves upon said surface while in a natural, walking position.

12. A method for marking extended lines, curves, and circles upon a surface comprising the steps of: using a spacing guide having a rigid body positioned in approximately a vertical position, the rigid body including generally vertically positioned members, and horizontally positioned members slidably mounted providing adjustability to the rigid body; a guide wheel means attached to said rigid body for rolling against a vertical surface; a plurality of street wheels attached at the bottom of the rigid body providing balance and stability to the unit; a scale and moveable pointer mounted near the bottom of the said rigid body, using said scale and pointer as an optical sighting means for marking lines at a measured distance away from an existing reference point on the ground; having a marking material source with a handle and trigger means attached for releasing marking material such as paint, chalk, or tape from a reservoir located on one end of the said rigid body, using said marking material to mark lines and curves on a surface; and a second handle for another hand of the user disposed on the said rigid body, and using said second handle for pushing and steering the unit while drawing in an erect walking position.

13. The method for marking extended lines and curves described in claim 12, wherein the embodied pointer means is a spike, and further comprising the step of planting said spike onto a surface, and using said spike as a pivot point of the unit, providing a radius for drawing circles and curves upon said surface while in a natural, walking position.

14. The method for marking extended lines described in claim 12, wherein at least one housing and laser is mounted upon the pointer, and further comprising the step of using said laser as an extended optical sighting means upon the ground in the direction of travel.

15. The method for marking extended lines described in claim 12, wherein a laser is mounted in a direction perpendicular to the line of travel, and comprising the step of pointing said laser at a measuring rod, and using said laser as a means to read elevations on the said measuring rod.

16. The method for marking extended lines and curves described in claim 12, wherein a first laser is mounted as a pointer means, and further comprising the steps of using said first laser as an extended optical sighting means on the ground, in the direction of travel; having an electronic distance measuring device mounted and aimed in a direction perpendicular to the line of travel, and using said electronic measuring device as a means for measuring offset distances from an existing vertical surface, viewing said measured distance on an embodied read out screen, and marking a corresponding line.

17. The method for marking extended lines in claim 12, including the step of having a second paint source a distance away from the first paint source, for simultaneously marking a second parallel line.

18. A spacing guide and marking apparatus comprising: a rigid body positioned in approximately a vertical position, the rigid body including vertically and horizontally positioned members providing a spacing between two marking material sources, the said sources containing marking material such as paint, chalk, or tape; a plurality of street wheels attached to the bottom of said rigid body, and positioned parallel to the direction of travel providing balance and stability to the unit; a pointer used as an optical sighting means for steering the unit in the forward direction of travel; at least one laser mounted in a forward direction, used as an extended optical sighting means on the ground; a marking material source having a handle and trigger means for releasing said marking material attached at one end of the rigid body, and a second marking material source at the opposite end of the rigid body for marking two parallel lines a distance apart, the said distance equal to the breadth of the rigid body between the two said marking material sources.

19. The spacing guide and marking apparatus in claim 18, comprising at least one electronic distance measuring device mounted and pointed in a direction approximately perpendicular to the direction of travel, the said electronic distance measuring device capable of measuring the offset distance from the unit to a vertical surface; and a digital readout screen displaying the said offset distance in view of the user.

20. The spacing guide in claim 18 wherein the rigid body is collapsible for easy storage and transporting.
